(19) United States
(12) Patent Application Publication
(10) Pub. No.: US 2017/0060260 A1
(43) Pub. Date: Mar. 2, 2017

(54) METHOD AND DEVICE FOR CONNECTING EXTERNAL EQUIPMENT

(71) Applicant: Xiaomi Inc., Beijing (CN)

(72) Inventors: Zhengan WANG, Beijing (CN); Laijun YAN, Beijing (CN); Junzhou WU, Beijing (CN)

(73) Assignee: Xiaomi Inc., Beijing (CN)

(21) Appl. No.: 15/180,635

(22) Filed: Jun. 13, 2016

(30) Foreign Application Priority Data
Aug. 28, 2015 (CN) 201510544228.1

(51) Int. Cl. G06F 3/023; G06F 3/02; H04L 5/00; H04W 4/00; H04L 12/26

(52) U.S. Cl. CPC G06F 3/0231; H04W 4/008; H04L 43/0811; H04L 5/0055; G06F 3/0219; H04W 88/02

(57) ABSTRACT

The present disclosure relates to methods and devices for connecting external equipment. The method may include in response to detecting that the external equipment is connected with a smart terminal, acquiring description information of the external equipment. The method may further include determining a keyboard type of the external equipment, based upon the acquired description information of the external equipment. The method may further include generating an equipment acknowledgement of, and establishing a connection to, the external equipment, based upon the determined keyboard type. Technical solutions presented herein may provide that, when equipment (such as a smart terminal) connects with external equipment, if a user is to perform an input operation, it may be determined whether to perform the input operation with a soft keyboard of an input system or to perform the input operation with the external equipment, based upon the determined keyboard type, which may ensure that the user may effectively perform the input operation and improve the user experience.

### CROSS-REFERENCE TO RELATED APPLICATIONS

The present application is based upon and claims priority to Chinese Patent Application No. 201510544228.1, filed Aug. 28, 2015, the entire contents of which are incorporated herein by reference.

### TECHNICAL FIELD

The present disclosure generally relates to the field of equipment connection technology, and more particularly, to methods and devices for connecting external equipment.

### BACKGROUND

Because camera functions of mobile terminals have become more and more mature, many people around the world can now take photos with a terminal. There are more and more situations where people take self-portraits, and because BLUETOOTH selfie sticks facilitate taking of self-portraits, they have emerged at the right moment.

After the terminal connects with the BLUETOOTH selfie stick via BLUETOOTH, the user may take photos by triggering an electronic shutter of the terminal using controls of the BLUETOOTH selfie stick.

### SUMMARY

Embodiments of the present disclosure provide methods and devices for connecting external equipment, including the following technical solutions.

According to a first aspect of embodiments of the present disclosure, there is provided a method for connecting a smart terminal to external equipment, applied in a smart terminal. The method may include, in response to detecting that external equipment is connected with the smart terminal, acquiring description information of the external equipment. The method may further include determining a keyboard type of the external equipment, based upon the acquired description information of the external equipment. The method may further include generating an equipment acknowledgement of the external equipment, based upon the determined keyboard type. The method may further include establishing a connection to the external equipment, based upon the determined keyboard type.

According to a second aspect of embodiments of the present disclosure, there is provided a method for connecting external equipment to a smart terminal, applied in the external equipment. The method may include, in response to detecting that a smart terminal is connected with the external equipment, reporting description information of the external equipment. The method may further include establishing a connection of the external equipment to the smart terminal, based upon the reported description information of the external equipment.

According to a third aspect of embodiments of the present disclosure, there is provided a device for connecting a smart terminal to external equipment. The device may include a processor and a memory for storing instructions executable by the processor. The processor may be configured to, in response to detecting that external equipment is connected with a smart terminal, acquire description information of the external equipment. The processor may be further configured to determine a keyboard type of the external equipment, based upon the acquired description information of the external equipment. The processor may be further configured to generate an equipment acknowledgement of the external equipment, based upon the determined keyboard type. The processor may be further configured to establish a connection of the smart terminal to the external equipment, based upon the determined keyboard type.

According to a fourth aspect of embodiments of the present disclosure, there is provided a device for connecting external equipment to a smart terminal. The device may include a processor and a memory for storing instructions executable by the processor. The processor may be configured to, in response to detecting that a smart terminal is connected with the external equipment, report description information of the external equipment. The processor may be further configured to establish a connection of the external equipment to the smart terminal, based upon the reported description information of the external equipment.

A technical scheme according to embodiments of the present disclosure may have the following beneficial effects.

In above technical solutions, when equipment (such as a smart terminal) connects with external equipment (such as a BLUETOOTH selfie stick), the equipment acquires description information of the external equipment, and determines a keyboard type of the external equipment, based upon the acquired description information of the external equipment. For example, the smart terminal may determine whether the external equipment is of an alphanumeric keyboard type or a partial keyboard type. The equipment then generates an equipment acknowledgement of the external equipment, based upon the determined keyboard type, and establishes a connection of the smart terminal to the external equipment, based upon the determined keyboard type. In this way, when the equipment connects with the external equipment, if a user needs to perform an input operation, it may be determined whether to perform the input operation with a soft keyboard input system or to perform the input operation with a keyboard of the external equipment, based upon the keyboard type, which may ensure that the user can effectively perform the input operation and improve the user experience.

It is to be understood that both the foregoing general description and the following detailed description are exemplary and explanatory only and are not restrictive of the disclosure or claims.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart illustrating a method for connecting external equipment according to an exemplary embodiment.

FIG. 2 is a flow chart illustrating a method for connecting a smart terminal to external equipment according to an exemplary embodiment.

FIG. 3 is a flow chart illustrating a method for connecting a smart terminal to external equipment according to an exemplary embodiment.

FIG. 4 is a flow chart illustrating a method for connecting a smart terminal to external equipment according to an exemplary embodiment.

FIG. 5 is a flow chart illustrating a method for connecting a smart terminal to external equipment according to a yet further exemplary embodiment.

FIG. 6 is a flow chart illustrating a method for connecting a smart terminal to external equipment according to an exemplary embodiment.

FIG. 7 is a flow chart illustrating a method for connecting external equipment to a smart terminal according to an exemplary embodiment.

FIG. 8 is a flow chart illustrating a method for connecting external equipment to a smart terminal according to an exemplary embodiment.

FIG. 9 is a flow chart illustrating a method for connecting external equipment to a smart terminal according to an exemplary embodiment.

FIG. 10 is a flow chart illustrating a method for connecting external equipment to a smart terminal according to an exemplary embodiment.

FIG. 11 is a flow chart illustrating a method for connecting external equipment to a smart terminal according to an exemplary embodiment.

FIG. 12 is a flow chart illustrating a method for connecting external equipment to a smart terminal according to an exemplary embodiment.

FIG. 13 is a block diagram of a device for connecting a smart terminal to external equipment according to an exemplary embodiment.

FIG. 14 is a block diagram of an acquiring module in a device for connecting a smart terminal to external equipment according to an exemplary embodiment.

FIG. 15 is a block diagram of a determining module in a device for connecting a smart terminal to external equipment according to an exemplary embodiment.

FIG. 16 is a block diagram of an acquiring module in a device for connecting a smart terminal to external equipment according to an exemplary embodiment.

FIG. 17 is a block diagram of a determining module in a device for connecting a smart terminal to external equipment according to an exemplary embodiment.

FIG. 18 is a block diagram of an acquiring module in a device for connecting a smart terminal to external equipment according to an exemplary embodiment.

FIG. 19 is a block diagram of a determining module in a device for connecting a smart terminal to external equipment according to an exemplary embodiment.

FIG. 20 is a block diagram of a first connecting module in a device for connecting a smart terminal to external equipment according to an exemplary embodiment.

FIG. 21 is a block diagram of a device for connecting a smart terminal to external equipment according to an exemplary embodiment.

FIG. 22 is a block diagram of a device for connecting external equipment to a smart terminal according to an exemplary embodiment.

FIG. 23 is a block diagram of a device for connecting external equipment to a smart terminal according to an exemplary embodiment.

FIG. 24 is a block diagram of a setting module in a device for connecting external equipment to a smart terminal according to an exemplary embodiment.

FIG. 25 is a block diagram of a setting module in a device for connecting external equipment to a smart terminal according to an exemplary embodiment.

FIG. 26 is a block diagram of a setting module in a device for connecting external equipment to a smart terminal according to an exemplary embodiment.

FIG. 27 is a block diagram of a device for connecting external equipment to a smart terminal according to an exemplary embodiment.

FIG. 28 is a block diagram of a device for connecting a smart terminal and external equipment according to an exemplary embodiment.

### DETAILED DESCRIPTION

Reference will now be made in detail to exemplary embodiments, examples of which are illustrated in the accompanying drawings. The following description refers to the accompanying drawings, in which the same numbers in different drawings represent the same or similar elements unless otherwise noted. The implementations set forth in the following description of exemplary embodiments do not represent all implementations consistent with the disclosure. Instead, they are merely examples of apparatuses and methods consistent with aspects of the disclosure recited in the appended claims.

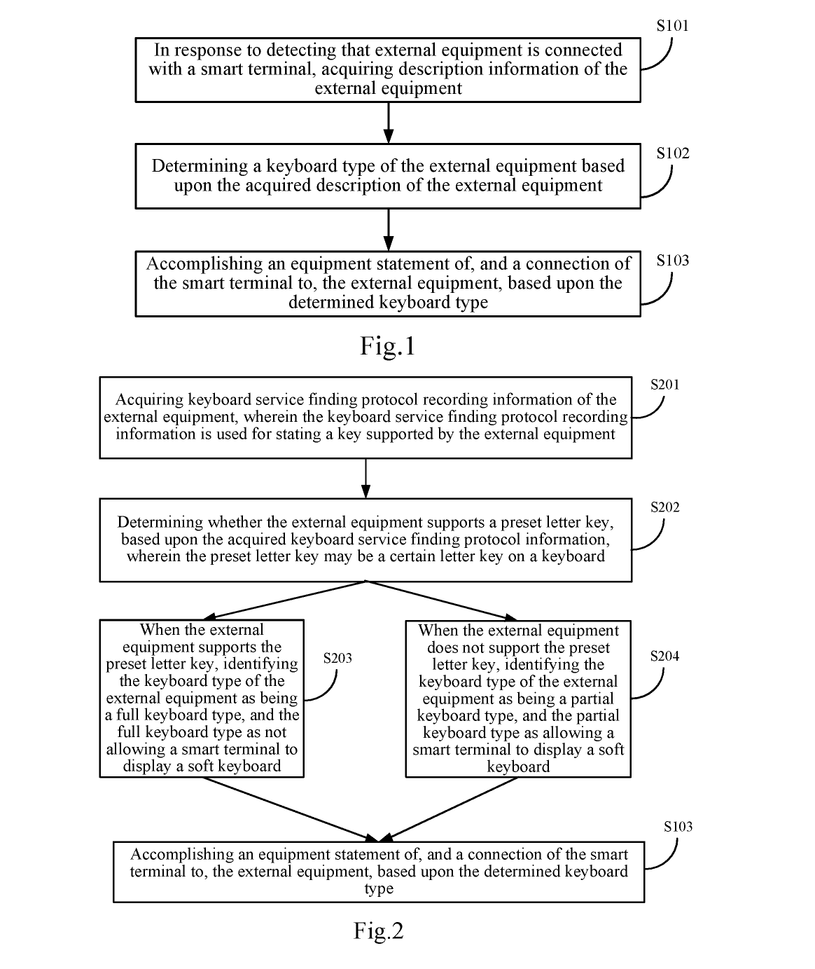

Embodiments of the present disclosure provide a method for connecting external equipment. A method may be applied in terminal equipment to be connected with the external equipment. As shown in FIG. 1, a method includes steps S101-S103.

In step S101, in response to detecting that the external equipment is connected with the smart terminal, description information of the external equipment is acquired. In one embodiment, description information of external equipment is set based upon at least one predetermined characteristic of a keyboard of the external equipment.

In step S102, a keyboard type of the external equipment is determined based upon the acquired description information of the external equipment.

In step S103, an equipment statement of, and a connection of the smart terminal to, the external equipment is accomplished, based upon the determined keyboard type. When the smart terminal accomplishes an equipment statement of, and connection to, the external equipment, the step may include the smart terminal performing a handshake with the external equipment, based upon the determined keyboard type. The smart terminal may generate an acknowledgement of the external equipment based upon the determined keyboard type, and establish a connection with the external equipment based upon the determined keyboard type.

In a present embodiment, when equipment (such as a smart terminal) connects with external equipment (such as a BLUETOOTH selfie stick), the equipment in response acquires description information of the external equipment, and determines a type of keyboard of the external equipment, based upon the acquired description information of the external equipment. For example, the smart terminal may determine whether the keyboard type of the external equipment is a full keyboard type (such as a QWERTY keyboard type and/or an alphanumeric keyboard type) or a partial keyboard type (such as a numeric keyboard type). The equipment (such as the smart terminal) then accomplishes an equipment statement of, and a connection to, the external equipment, based upon the determined keyboard type. In this way, when the equipment connects with the external equipment, if a user needs to perform an input operation, it may be determined whether to perform the input operation with a soft keyboard input system or to perform the input operation with a keyboard of the external equipment, based upon the keyboard type, which may ensure that the user can effectively perform the input operation and improve the user experience.

As shown in FIG. 2, in one embodiment, acquiring the description information of the external equipment in the above step S101 may include step S201.

In step S201, keyboard service finding protocol recording information of the external equipment is acquired, wherein the keyboard service finding protocol recording information is configured to be used for stating a key that is supported by the external equipment. Keyboard service finding protocol recording information of the external equipment may be acquired from the external equipment, which may report to the smart terminal the keyboard service finding protocol recording information of the external equipment in a manner consistent with step S701 discussed in further detail below.

The above step S102 may further include steps S202-S204.

In step S202, it is determined whether the external equipment supports a preset letter key, based upon the acquired keyboard service finding protocol recording information, wherein the preset letter key may be a certain letter key on a keyboard.

In step S203, when the external equipment is determined to support the preset letter key, the keyboard type of the external equipment is identified as being a full keyboard type, and the full keyboard type is identified as not allowing a smart terminal to display a soft keyboard input system for input.

In step S204, when the external equipment is determined not to support the preset letter key, the keyboard type of the external equipment is identified as being a partial keyboard type, and the partial keyboard type is identified as allowing a smart terminal to display a soft keyboard input system for input.

For example, the external equipment may be a BLUETOOTH selfie stick, which may be determined not to support the preset letter key, based upon its service finding protocol recording information. The preset letter key may include, but is not limited to, a “Q” key. For example, if the BLUETOOTH selfie stick does not support the “Q” key, then the keyboard type of the BLUETOOTH selfie stick may be identified as being a partial keyboard type. Therefore, when an input needs to be performed, the soft keyboard input system, such as a software-based keyboard or a virtual keyboard on a touchscreen of the terminal, is allowed to be displayed, thus ensuring that the user may effectively perform the input operation when using the BLUETOOTH selfie stick.

Thus in an above embodiment, the keyboard type is identified by determining whether the external equipment supports use of the preset letter key, and it is determined whether to perform an input operation with a soft keyboard input system or to perform the input operation with the external equipment, based upon the identified keyboard type. This may ensure that the user may effectively perform the input operation and improve the user experience.

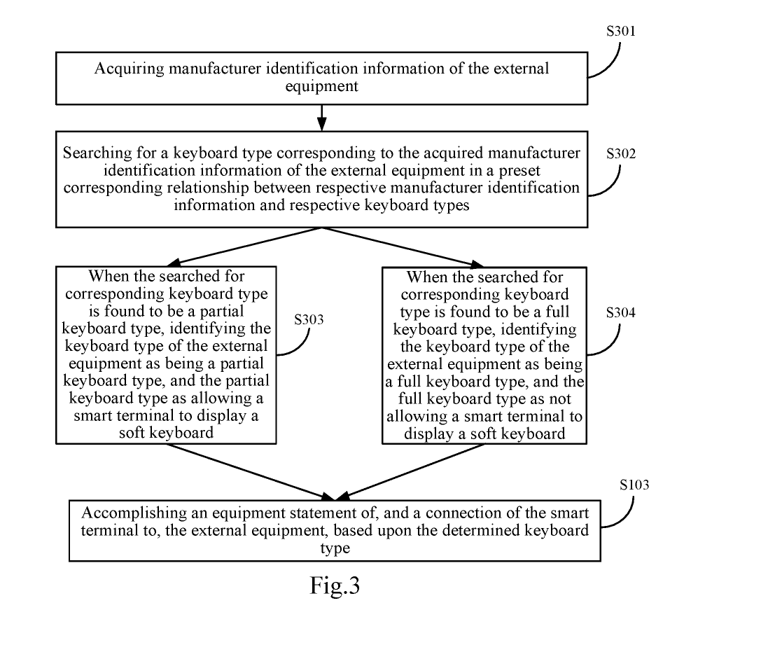

As shown in FIG. 3, in one embodiment, acquiring the description information of the external equipment in the above step S101 may include step S301.

In step S301, manufacturer identification information of the external equipment is acquired. Manufacturer identification information of the external equipment may be acquired from the external equipment, which may report the manufacturer identification information to the smart terminal in a manner consistent with step S701 discussed in further detail below.

The above step S102 may include steps S302-S304.

In step S302, a keyboard type corresponding to the acquired manufacturer identification information of the external equipment is searched for in a preset corresponding relationship between respective manufacturer identification information and respective keyboard types.

In step S303, when the searched for corresponding keyboard type is found to be a partial keyboard type, the keyboard type of the external equipment is identified as being a partial keyboard type, and the partial keyboard type is identified as allowing a smart terminal to display a soft keyboard input system for input operations.

In step S304, when the searched for corresponding keyboard type is found to be a full keyboard type, the keyboard type of the external equipment is identified as being a full keyboard type, and that the full keyboard type is identified as not allowing a smart terminal to display a soft keyboard input system for input operations.

For different kinds of external equipment, the manufacturer identification information may be different. For example, the respective manufacturer identification information of a BLUETOOTH selfie stick and an external keyboard may be different. Therefore, different relationships between respective manufacturer identification information and corresponding respective keyboard type may be preset. For example, the manufacturer identification information of a BLUETOOTH selfie stick may correspond to a partial keyboard type, and manufacturer identification information of an external keyboard may correspond to a full keyboard type. Then, for example, when the external equipment is to be connected, the respective manufacturer identification information of that respective external equipment is acquired, and the keyboard type of that external equipment is determined based on the manufacturer identification information.

Thus in an above embodiment, a keyboard type is identified based upon respective preset manufacturer identification information of respective kinds of external equipment, and it is determined whether to perform the input operation with a soft keyboard input system or to perform the input operation with the external equipment based upon the keyboard type, which may ensure that the user can effectively perform the input operation and improve the user experience.

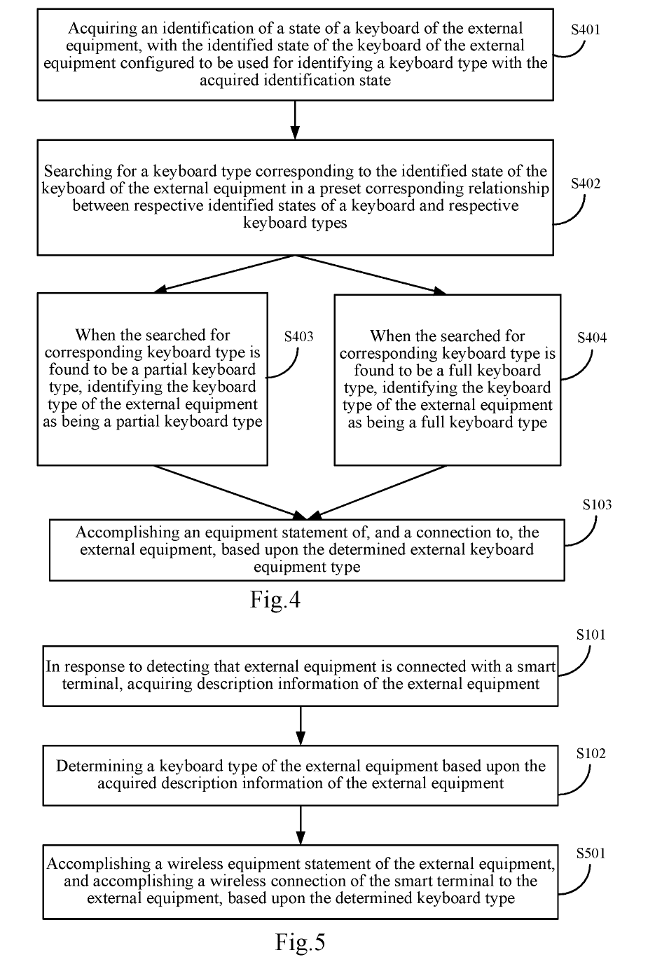

As shown in FIG. 4, in one embodiment, acquiring the description information of the external equipment in the above step S101 may include step S401.

In step S401, an identification of a state of a keyboard of the external equipment is acquired, with the identified state of the keyboard of the external equipment configured to be used for identifying a keyboard type with the acquired identification of state. An identification of a state of a keyboard of the external equipment may be acquired from the external equipment, which may report to the smart terminal the identification of the state of the keyboard of the external equipment in a manner consistent with step S701 discussed in further detail below.

The above step S102 may include steps S402-S404.

In step S402, a keyboard type corresponding to the identified state of a keyboard of the external equipment is searched for in a preset corresponding relationship between respective identified states of a keyboard and respective keyboard types.

In step S403, when the searched for corresponding keyboard type is found to be a partial keyboard type, the keyboard type of the external equipment is identified as being a partial keyboard type.

In step S404, when the searched for corresponding keyboard type is found to be a full keyboard type, the keyboard type of the external equipment is identified as being a full keyboard type.

For example, a keyboard type may be further determined based upon an identified on-off state of a keyboard of the external equipment. An identification of an on-off state of a keyboard may include an “on” state or an “off” state. It may be a preset relationship that a corresponding keyboard type is a full keyboard type when the on-off state of a keyboard is identified as being in an “on” state, and the corresponding keyboard type is a partial keyboard type when the on-off state of a keyboard is identified as being in an “off” state.

Thus in an above embodiment, a keyboard type is determined based upon an identified on-off state of a keyboard of external equipment, and it is determined whether to perform the input operation with a soft keyboard input system or to perform the input operation with the external equipment based upon the determined keyboard type, which may ensure that the user can effectively perform the input operation and improve the user experience.

As shown in FIG. 5, in one embodiment, the above step S103 may include step S501.

In step S501, a wireless equipment statement of the external equipment is accomplished, and a wireless connection of the smart terminal to the external equipment is accomplished, based upon the determined keyboard type.

In a present embodiment, external equipment may be wireless external equipment. Equipment (such as a terminal) may accomplish, or establish, a wireless connection with wireless external equipment, and may generate an equipment statement, such as an equipment acknowledgement, of the wireless external equipment, based upon the determined keyboard type of the external equipment, which may ensure effective use of the external equipment and effective use of the soft keyboard input system at the same time.

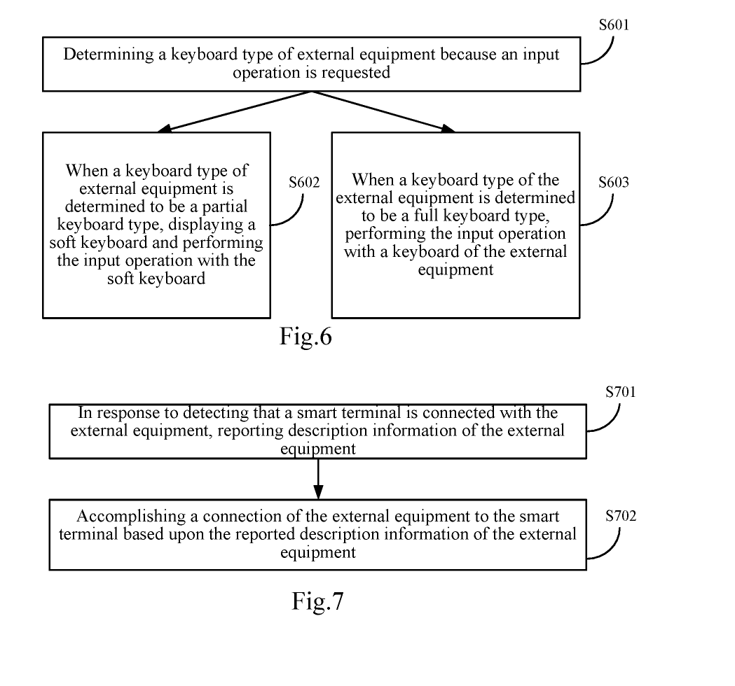

As shown in FIG. 6, in one embodiment, the above methods may further include steps S601-S603.

In step S601, a keyboard type of external equipment is determined because an input operation is requested.

In step S602, when a keyboard type of external equipment is determined as being a partial keyboard type, a soft keyboard input system is displayed and the input operation is performed with the soft keyboard input system.

In step S603, when the keyboard type of the external equipment is determined as being full keyboard type, the input operation is performed with a keyboard of the external equipment.

Thus in an above embodiment, in response to a determination that an input operation is needed, it may be determined how to perform an input operation based upon a keyboard type of the external equipment. For example, in response to a determination that a keyboard type of external equipment is a partial keyboard type, a soft keyboard input system is displayed, for example on the terminal, and the input operation is performed with the soft keyboard input system. As another example, in response to a determination that a keyboard type of external equipment is a full keyboard type, an input operation is performed with a keyboard of the external equipment. In this way, it may be ensured that an input operation is effectively performed no matter the keyboard type of the external equipment.

Embodiments of the present disclosure further provide a method for connecting external equipment. A method may be applied in external equipment (for example, an external keyboard, a wireless selfie stick, or the like). As shown in FIG. 7, a method may include steps S701-S702.

In step S701, in response to detecting that a smart terminal is connected with the external equipment, description information of the external equipment is reported.

In step S702, a connection of the external equipment to the smart terminal is accomplished based upon the reported description information of the external equipment.

In a present embodiment, external equipment may report description information of the external equipment to a smart terminal, and then accomplish a connection to the smart terminal based upon the reported description information.

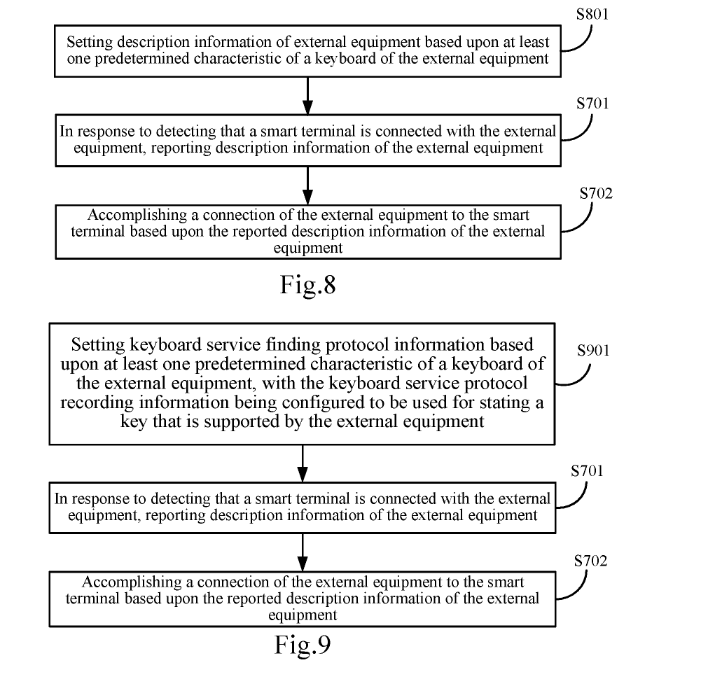

As shown in FIG. 8, in one embodiment, an above method may further include step S801.

In step S801, before a connection with a smart terminal, description information of external equipment is set based upon at least one predetermined characteristic of a keyboard of the external equipment.

In a present embodiment, description information of external equipment is set based upon at least one predetermined characteristic of a keyboard of the external equipment. In this way, a method may avoid setting by default the description information of all external equipment to be description information corresponding to a full keyboard type, which might otherwise prevent a soft keyboard input system from being used when external equipment is being used. In this way, it may be ensured that the user may effectively perform the input operation no matter the external keyboard type of the external equipment.

As shown in FIG. 9, in one embodiment, setting the description information of external equipment based upon at least one predetermined characteristic of a keyboard of the external equipment in the above step S801 may include step S901.

In step S901, keyboard service finding protocol recording information is set based upon at least one predetermined characteristic of a keyboard of the external equipment, with the keyboard service finding protocol recording information configured to be used for stating a key that is supported by the external equipment. When the keyboard type of the external equipment is a full keyboard type, the keyboard service finding protocol recording information may state that the external equipment supports a preset letter key. When the keyboard type of the external equipment is a partial keyboard type, the keyboard service finding protocol recording information may state that the external equipment does not support the preset letter key.

In a present embodiment, keyboard service finding protocol recording information may be set based upon at least one predetermined characteristic of a keyboard of the external equipment, with the keyboard service finding protocol recording information configured to be used for stating a key that is supported by the external equipment. In this way, the external equipment may state that it supports those keys which it needs. For example, when the external equipment is a BLUETOOTH selfie stick, it may not need the full keyboard input, and it may then be determined that the BLUETOOTH selfie stick is of the partial keyboard type. At this time, the keyboard service finding protocol recording information may state which keys the BLUETOOTH selfie stick does not support. For example, the BLUETOOTH selfie stick may not support the letter “Q” key. In this way, when the BLUETOOTH selfie stick connects with other equipment, for example, various terminals, the keyboard type of the external equipment is determined based upon the keyboard service finding protocol recording information. If the user needs to perform an input operation, it may be determined whether that input operation is allowed to use a soft keyboard input system based upon the determined keyboard type, which may ensure an effective input operation and improve the user experience.

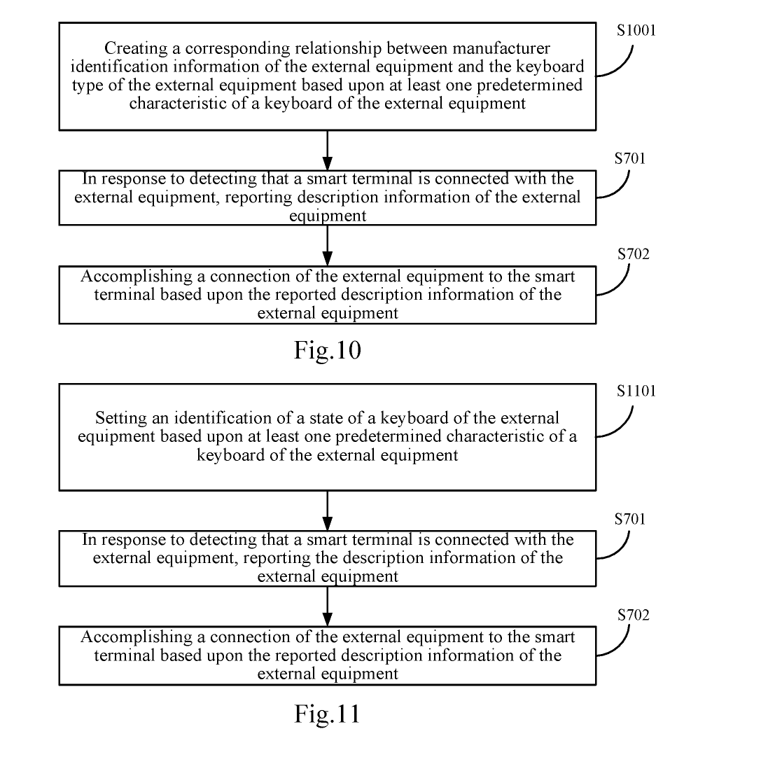

As shown in FIG. 10, in one embodiment, setting the description information of external equipment based upon at least one predetermined characteristic of a keyboard of the external equipment in above step S801 may include step S1001.

In step S1001, a corresponding relationship is created between the manufacturer identification information of the external equipment and the keyboard type of the external equipment based upon at least one predetermined characteristic of a keyboard of the external equipment.

For example, when a keyboard type of the external equipment is a full keyboard type, a corresponding relationship may be created between the manufacturer identification information of the external equipment and the full keyboard type. For example, when a keyboard type of the external equipment is a partial keyboard type, a corresponding relationship may be created between the manufacturer identification information of that external equipment and the partial keyboard type.

In a present embodiment, for different respective external equipment, the respective manufacturer identification information may be different. For example, the respective manufacturer identification information of the BLUETOOTH selfie stick and the external keyboard may be different. Therefore, different relationships between respective manufacturer identification information and corresponding respective keyboard type may be preset. For example, manufacturer identification information of a BLUETOOTH selfie stick may correspond to the partial keyboard type, and manufacturer identification information of an external keyboard may correspond to the full keyboard type. Then, for example, when the external equipment needs to be connected to equipment, the respective manufacturer identification information of that respective external equipment is acquired, and the keyboard type of that respective external equipment is determined based upon the respective manufacturer identification information of that respective external equipment.

As shown in FIG. 11, in one embodiment, setting the description information based upon at least one predetermined characteristic of a keyboard of the external equipment in above step S801 may include step S1101.

In step S1101, an identification of a state of a keyboard of the external equipment is set based upon at least one predetermined characteristic of a keyboard of the external equipment.

For example, when the keyboard type of the external equipment is a full keyboard type, the identification of the on-off state of the keyboard of the external equipment may be set as a first on-off state, and when the keyboard type of the external equipment is a partial keyboard type, the identification of the on-off state of the keyboard of the external equipment may be set as a second on-off state.

In a present embodiment, identifications of on-off states of the keyboard of the external equipment may include a first on-off state and a second on-off state (for example, an “on” state and an “off” state). It may be preset that the corresponding keyboard type is the full keyboard type when the identification of the on-off state of the keyboard is of the first on-off state. It may be preset that the corresponding keyboard type is the partial keyboard type when the identification of the on-off state of keyboard is of the second on-off state.

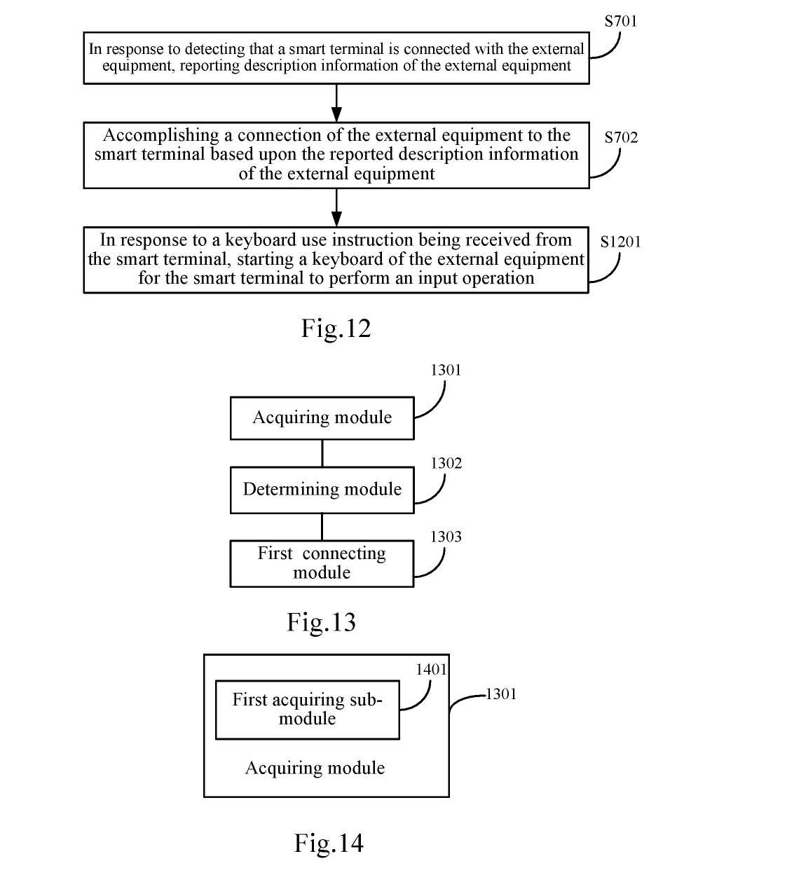

As shown in FIG. 12, in one embodiment, a method may further include step S1201.

In step S1201, in response to a keyboard use instruction being received from a smart terminal, starting a keyboard of the external equipment for the smart terminal to perform an input operation.

In a present embodiment, when external equipment receives a keyboard use instruction from a smart terminal, a keyboard of the external equipment is started for the smart terminal to perform an input operation. However, when the external equipment does not receive a keyboard use instruction from the smart terminal, the smart terminal may perform an input operation using a soft keyboard input system. In this way, it may be ensured that an input operation is effectively performed no matter the keyboard type of the respective external equipment.

In following embodiments of devices according to the present disclosure, devices may be configured to perform methods of above embodiments of the present disclosure.

FIG. 13 is a block diagram illustrating a device for connecting external equipment according to an exemplary embodiment. The device may constitute a part or all of a terminal, and may be implemented as software, hardware, or combinations thereof. As shown in FIG. 13, a device for connecting external equipment may include an acquiring module 1301 configured to, in response to detecting that external equipment is connected with a smart terminal, acquire description information of the external equipment. The device may further include a determining module 1302 configured to determine a keyboard type of the external equipment based upon the acquired description information of the external equipment acquired by the acquiring module 1301. The device may further include a first connecting module 1303 configured to generate an equipment acknowledgement of the external equipment, and establish a connection to the external equipment, based upon the keyboard type determined by the determining module 1302.

In one embodiment, description information of external equipment is set based upon at least one predetermined characteristic of a keyboard of the external equipment.

As shown in FIG. 14, in one embodiment, an acquiring module 1301 may include a first acquiring sub-module 1401 configured to acquire keyboard service finding protocol recording information of the external equipment, wherein the keyboard service finding protocol recording information is configured to be used for stating that a key is supported by the external equipment.

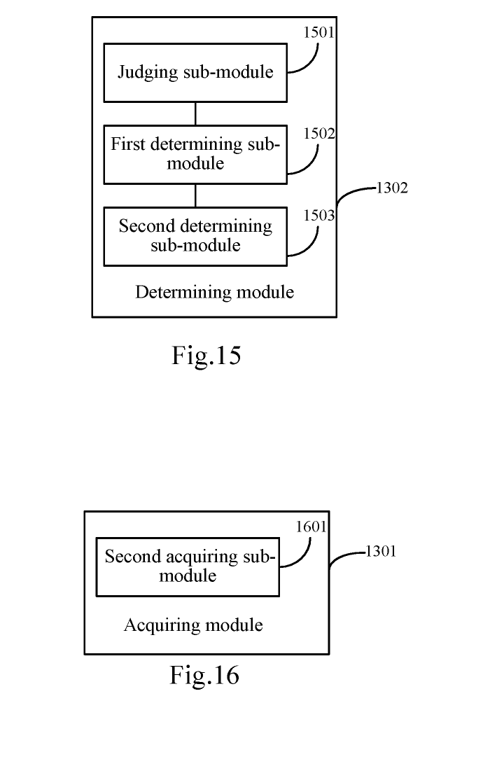

As shown in FIG. 15, determining module 1302 may include a judging sub-module 1501 configured to determine whether the external equipment supports a preset letter key, based upon the keyboard service finding protocol recording information acquired by the first acquiring sub-module 1401. Determining module 1302 may further include a first determining sub-module 1502 configured to, in response to the judging sub-module 1501 determining that the external equipment supports the preset letter key, identify the keyboard type of the external equipment as being a full keyboard type. Determining module 1302 may further include a second determining sub-module 1503 configured to, in response to the judging sub-module 1501 determining that the external equipment does not support the preset letter key, identify the keyboard type of the external equipment as being a partial keyboard type, and identify the partial keyboard type as allowing a smart terminal to display a soft keyboard input system during an input operation.

As shown in FIG. 16, in one embodiment, acquiring module 1301 may include a second acquiring sub-module 1601 configured to acquire manufacturer identification information of the external equipment.

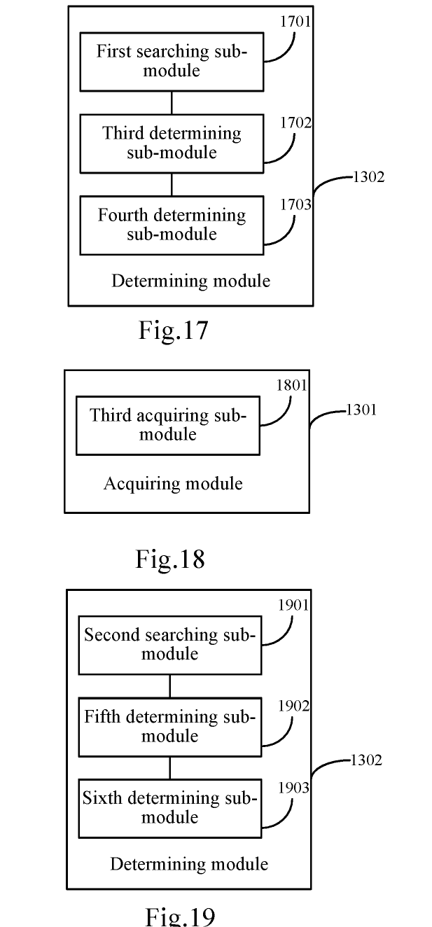

As shown in FIG. 17, in one embodiment, determining module 1302 may include a first searching sub-module 1701 configured to search for a keyboard type corresponding to respective manufacturer identification information of the external equipment that is acquired by the second acquiring sub-module 1601, in a preset corresponding relationship between respective manufacturer identification information and respective keyboard types.

Determining module 1302 may further include a third determining sub-module 1702 configured to, in response to the keyboard type searched for by the first searching sub-module 1701 being found to be a partial keyboard type, identify the keyboard type of the external equipment as being a partial keyboard type.

Determining module 1302 may further include a fourth determining sub-module 1703 configured to, in response to the keyboard type searched for by the first searching sub-module being found to be a full keyboard type, identify the keyboard type of the external equipment as being a full keyboard type.

As shown in FIG. 18, in one embodiment, acquiring module 1301 may include a third acquiring sub-module 1801 configured to acquire an identification of an on-off state of a keyboard of external equipment, with the identification of the on-off state of the keyboard of the external equipment configured to be used for identifying a keyboard type with an on-off state.

As shown in FIG. 19, in one embodiment, determining module 1302 may include a second searching sub-module 1901 configured to search for a keyboard type corresponding to the identification of the on-off state of the keyboard of the external equipment acquired by the third acquiring sub-module, in a preset corresponding relationship between respective identified on-off states of a respective keyboard and respective keyboard types.

Determining module 1302 may further include a fifth determining sub-module 1902 configured to, in response to the corresponding keyboard type searched for by the second searching sub-module 1901 being found to be a partial keyboard type, identify the respective keyboard type of the respective external equipment as being a partial keyboard type.

Determining module 1302 may further include a sixth determining sub-module 1903 configured to, in response to the corresponding keyboard type searched for by the second searching sub-module 1901 being found to be a full keyboard type, identify the respective keyboard type of the respective external equipment as being a full keyboard type.

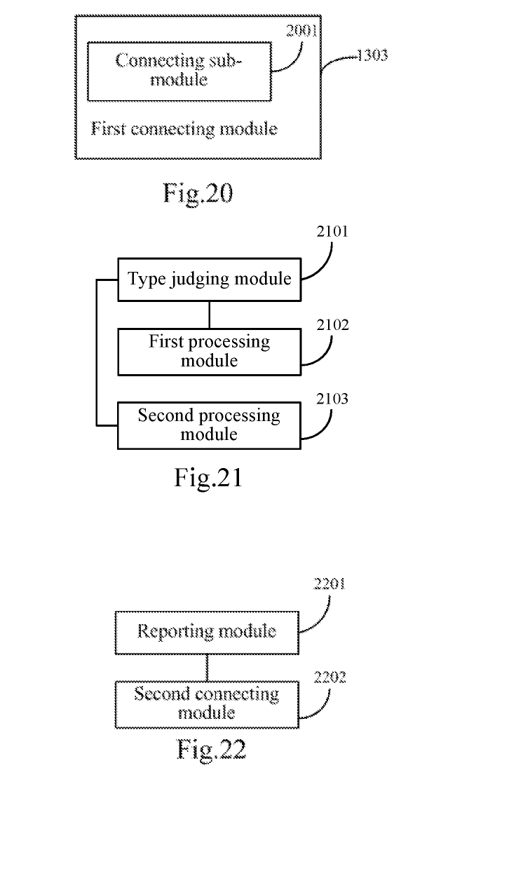

As shown in FIG. 20, in one embodiment, first connecting module 1303 may include a connecting sub-module 2001 configured to generate the wireless equipment acknowledgement of the external equipment and to establish the wireless connection of the smart terminal with the external equipment, based upon the keyboard type.

As shown in FIG. 21, in one embodiment, the device may further include a type judging module 2101 configured to determine the keyboard type of the external equipment because an input operation is needed.

The device may further include a first processing module 2102 configured to, in response to the type judging module 2101 determining that the keyboard type of the external equipment is a partial keyboard type, display on the smart terminal a soft keyboard input system and perform the input operation with the soft keyboard input system.

The device may further include a second processing module 2103 configured to, in response to the type judging module 2101 determining that the keyboard type of the external equipment is a full keyboard type, perform the input operation with a keyboard of the external equipment.

FIG. 22 is a block diagram illustrating a device for connecting external equipment according to an exemplary embodiment. The device may constitute a part or all of respective external equipment, and may be implemented by software, hardware, or combinations thereof. As shown in FIG. 22, a device for connecting external equipment may include a reporting module 2201 configured to, in response to detecting that a smart terminal is connected, report description information.

The device may further include a second connecting module 2202 configured to accomplish connection of the external equipment with the smart terminal based upon the description information reported by the reporting module 2201.

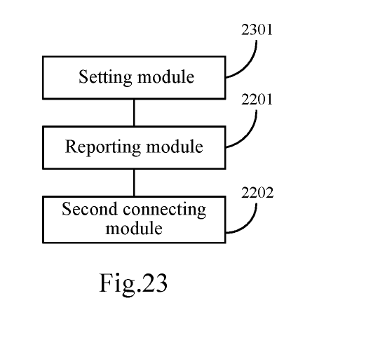

As shown in FIG. 23, in one embodiment, the device may further include a setting module 2301 configured to, before the connecting module is connected with the smart terminal, set the description information based upon.

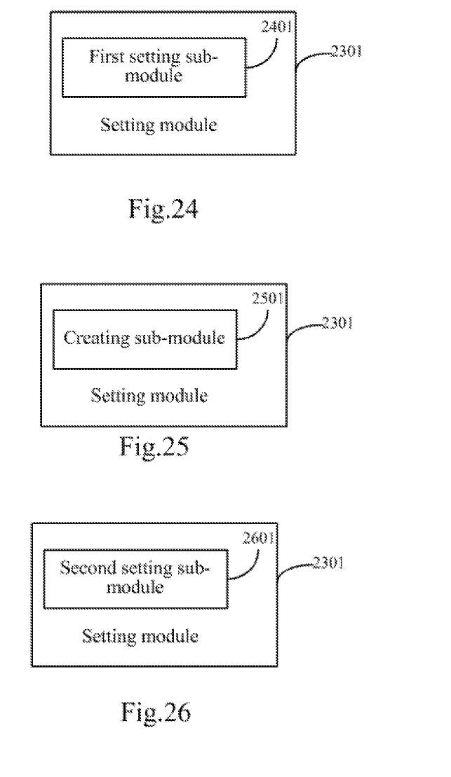

As shown in FIG. 24, in one embodiment, setting module 2301 may include a first setting sub-module 2401 configured to set keyboard service finding protocol recording information based upon at least one predetermined characteristic of a keyboard of the external equipment, with the keyboard service finding protocol recording information to be used for stating that a key is supported by the external equipment. When the keyboard type of the external equipment is a full keyboard type, the keyboard service finding protocol recording information may state that the external equipment supports a preset letter key. When the keyboard type of the external equipment is a partial keyboard type, the keyboard service finding protocol recording information may state that the external equipment does not support the preset letter key.

As shown in FIG. 25, in one embodiment, setting module 2301 may include a creating sub-module 2501 configured to create a corresponding relationship between the manufacturer identification information of the external equipment and the keyboard type of the external equipment, based upon at least one predetermined characteristic of a keyboard of the external equipment. When the keyboard type of the respective external equipment is a full keyboard type, a corresponding relationship may be created between the manufacturer identification information of the external equipment and a full keyboard type. When the keyboard type of the respective external equipment is a partial keyboard type, a corresponding relationship may be created between the manufacturer identification information of the external equipment and a partial keyboard type.

As shown in FIG. 26, in one embodiment, setting module 2301 may include a second setting sub-module 2601 configured to set an identification of an on-off state of a keyboard of the respective external equipment based upon at least one predetermined characteristic of a keyboard of the external equipment. When the keyboard type of the respective external equipment is a full keyboard type, the identification of the on-off state of the keyboard of the respective external equipment may be set as a first on-off state. When the keyboard type of the external equipment is a partial keyboard type, the identification of the on-off state of the keyboard of the external equipment may be set as a second on-off state.

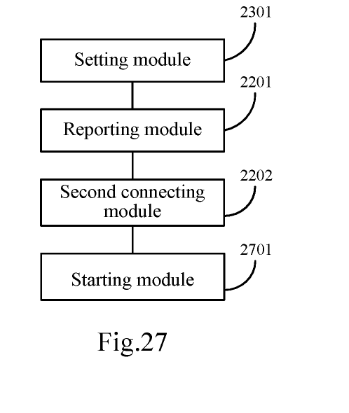

As shown in FIG. 27, in one embodiment, the device may further include a starting module 2701 configured to, in response to receiving a keyboard use instruction from the smart terminal, start the keyboard of the external equipment for the smart terminal to perform an input operation.

In one embodiment, a device for connecting external equipment may include a processor and a memory for storing instructions executable by the processor. The processor may be configured to, in response to detecting that the external equipment is connected, acquire description information of the external equipment. The processor may be further configured to determine a keyboard type of the external equipment based upon the acquired description information of the external equipment. The processor may be further configured to generate an equipment statement of, and establish a connection to, the external equipment, based upon the determined keyboard type. The processor may be further configured to perform any or all of the method steps S101-S103, S201-S204, S301-S304, S401-S404, S501, and S601-S603 as described above.

In one embodiment of the present disclosure, there is provided a device for connecting external equipment. The device may include a processor and a memory for storing instructions executable by the processor. The processor may be configured to, in response to detecting that a smart terminal is connected with external equipment, reporting description information. The processor may be further configured to accomplish a connection of the external equipment with the smart terminal based upon the reported description information. The processor may further be configured to perform any or all of steps S701, S702, S801, S901, S1001, S1101, and S1201 as described above.

Implementation of the functions and operations of the modules in the above devices may be specifically referred to the implementation of the corresponding steps in the above methods. The methods, devices, and modules described above may be implemented in many different ways and as hardware, software or in different combinations of hardware and software. For example, all or parts of the implementations may be a processing circuitry that includes an instruction processor, such as a central processing unit (CPU), microcontroller, a microprocessor; or application specific integrated circuits (ASICs), digital signal processors (DSPs), digital signal processing devices (DSPDs), programmable logic devices (PLDs), field programmable gate arrays (FPGAs), controllers, micro-controllers, microprocessors, other electronic components; or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples

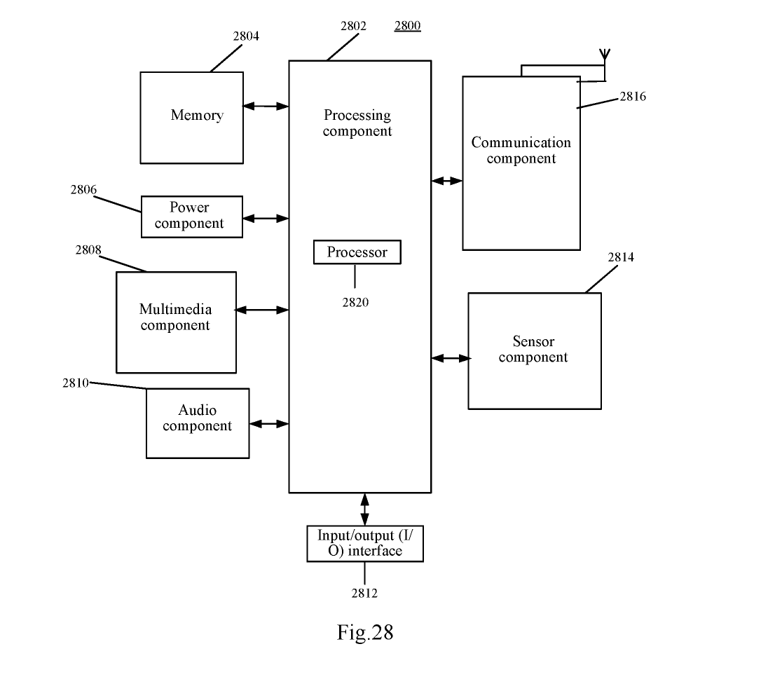

FIG. 28 is a block diagram of a device for connecting external equipment according to an exemplary embodiment. The device may be suitable for the terminal equipment. For example, the device 2800 may be a mobile phone, a computer, a digital broadcast terminal, a messaging device, a gaming console, a tablet, a medical device, exercise equipment, a personal digital assistant, and the like. The device may be suitable for the external equipment, for example, the device 2800 may be a BLUETOOTH selfie stick or an external keyboard.

The device 2800 may include one or more of the following components: a processing component 2802, a memory 2804, a power component 2806, a multimedia component 2808, an audio component 2810, an input/output (I/O) interface 2812, a sensor component 2814, and a communication component 2816.

The processing component 2802 typically controls overall operations of the device 2800, such as the operations associated with display, telephone calls, data communications, camera operations, and recording operations. The processing component 2802 may include one or more processors 2820 to execute instructions to perform all or part of the steps in the above described methods. Moreover, the processing component 2802 may include one or more modules which facilitate the interaction between the processing component 2802 and other components. For instance, the processing component 2802 may include a multimedia module to facilitate the interaction between the multimedia component 2808 and the processing component 2802. A smart terminal embodiment of processing component 2802 may include modules 1301-1303, 1401, 1501-1503, 1601, 1701-1703, 1801, 1901-1903, 2001, and 2101-2103, and 2701. An external equipment embodiment of processing component may include modules 2201, 2202, 2301, 2401, 2501, 2601, and 2701.

Each module discussed above, such as acquiring module 1301, determining module 1302, first connecting module 1303, first acquiring sub-module 1401, judging sub-module 1501, first determining sub-module 1502, second determining sub-module 1503, second acquiring sub-module 1601, first searching sub-module 1701, third determining sub-module 1702, fourth determining sub-module 1703, third acquiring sub-module 1801, second searching sub-module 1901, fifth determining sub-module 1902, sixth determining sub-module 1903, connecting sub-module 2001, type judging sub-module 2101, first processing module 2102, second processing module 2103, reporting module 2201, second connecting module 2202, setting module 2301, first setting sub-module 2401, creating sub-module 2501, second setting sub-module 2601, and starting module 2701, may take the form of a packaged functional hardware unit designed for use with other components, a portion of a program code (e.g., software or firmware) executable by the processor 2820 or the processing circuitry that usually performs a particular function of related functions, or a self-contained hardware or software component that interfaces with a larger system, for example.

The memory 2804 is configured to store various types of data to support the operation of the device 2800. Examples of such data include instructions for any applications or methods operated on the device 2800, contact data, phonebook data, messages, pictures, video, etc. The memory 2804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 2806 provides power to various components of the device 2800. The power component 2806 may include a power management system, one or more power sources, and any other components associated with the generation, management, and distribution of power in the device 2800.

The multimedia component 2808 includes a screen providing an output interface between the device 2800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 2808 includes a front camera and/or a rear camera. The front camera and the rear camera may receive an external multimedia datum while the device 2800 is in an operation mode, such as a photographing mode or a video mode. Each of the front camera and the rear camera may be a fixed optical lens system or have focus and optical zoom capability.

The audio component 2810 is configured to output and/or input audio signals. For example, the audio component 2810 includes a microphone (“MIC”) configured to receive an external audio signal when the device 2800 is in an operation mode, such as a call mode, a recording mode, and a voice recognition mode. The received audio signal may be further stored in the memory 2804 or transmitted via the communication component 2816. In some embodiments, the audio component 2810 further includes a speaker to output audio signals.

The I/O interface 2812 provides an interface between the processing component 2802 and peripheral interface modules, such as a keyboard, a click wheel, buttons, and the like. The buttons may include, but are not limited to, a home button, a volume button, a starting button, and a locking button.

The sensor component 2814 includes one or more sensors to provide status assessments of various aspects of the device 2800. For instance, the sensor component 2814 may detect an open/closed status of the device 2800, relative positioning of components, e.g., the display and the keypad, of the device 2800, a change in position of the device 2800 or a component of the device 2800, a presence or absence of user contact with the device 2800, an orientation or an acceleration/deceleration of the device 2800, and a change in temperature of the device 2800. The sensor component 2814 may include a proximity sensor configured to detect the presence of nearby objects without any physical contact. The sensor component 2814 may further include a light sensor, such as a CMOS or CCD image sensor, for use in imaging applications. In some embodiments, the sensor component 2814 may further include an accelerometer sensor, a gyroscope sensor, a magnetic sensor, a pressure sensor or a temperature sensor.

The communication component 2816 is configured to facilitate communication, wired or wirelessly, between the device 2800 and other devices. The device 2800 may access a wireless network based on a communication standard, such as WiFi, 2G, or 3G or a combination thereof. In one exemplary embodiment, the communication component 2816 receives a broadcast signal or broadcast associated information from an external broadcast management system via a broadcast channel. In one exemplary embodiment, the communication component 2816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a BLUETOOTH (BT) technology, and other technologies.

In exemplary embodiments, the device 2800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is further provided a non-transitory computer-readable storage medium including instructions, such as included in the memory 2804, executable by the processor 2820 in the device 2800, for performing the above-described methods. For example, the non-transitory computer-readable storage medium may be a ROM, a RAM, a CD-ROM, a magnetic tape, a floppy disc, an optical data storage device, and the like.

A non-transitory computer readable storage medium is provided, in which instructions stored in the storage medium are executed by a processor of a device 2800, the execution of those instructions by the processor of device 2800 causing device 2800 perform operations associated with the method steps and/or modules described above. For example, in one exemplary embodiment of this disclosure, the instructions are configured to cause a smart terminal embodiment of device 2800 to perform any or all of steps S101-S103, S201-S204, S301-S304, S401-S404, S501, and S601-S603 as described above. In another exemplary embodiment of this disclosure, the instructions are configured to cause an external equipment embodiment of device 2800 to perform any or all of steps S701, S702, S801, S901, S1001, S1101, and S1201 as described above.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for connecting a smart terminal to external equipment, applied in the smart terminal, the method comprising:
in response to detecting that the external equipment is connected with the smart terminal, acquiring description information of the external equipment;
determining a keyboard type of the external equipment, based upon the acquired description information of the external equipment;
generating an equipment acknowledgement of the external equipment, based upon the determined keyboard type; and
establishing a connection of the smart terminal to the external equipment, based upon the determined keyboard type.

2. The method of claim 1, wherein the acquired description information of the external equipment is set based upon at least one predetermined characteristic of a keyboard of the external equipment.

3. The method of claim 1, wherein:
acquiring the description information of the external equipment comprises:
acquiring keyboard service finding protocol recording information of the external equipment, wherein the acquired keyboard service finding protocol recording information is configured to be used for stating a key that is supported by the external equipment; and
determining the keyboard type of the external equipment based upon the acquired description information of the external equipment comprises:
determining whether the external equipment supports a preset letter key, based upon the acquired keyboard service finding protocol recording information;
when the external equipment is determined to support the preset letter key, identifying the keyboard type of the external equipment as being a full keyboard type; and
when the external equipment is determined not to support the preset letter key, identifying the keyboard type of the external equipment as being a partial keyboard type, and that the partial keyboard type allows the smart terminal to display a soft keyboard input system during an input operation.

4. The method of claim 1, wherein:
acquiring the description information of the external equipment comprises:
acquiring manufacturer identification information of the external equipment; and
determining the keyboard type of the external equipment based upon the acquired description information of the external equipment comprises:
searching for a keyboard type corresponding to the acquired manufacturer identification information of the external equipment in a preset corresponding relationship between respective manufacturer identification information and respective keyboard types;
when the searched for corresponding keyboard type is found to be a partial keyboard type, identifying the keyboard type of the external equipment as being a partial keyboard type; and
when the searched for corresponding keyboard type is found to be a full keyboard type, identifying the keyboard type of the external equipment as being a full keyboard type.

5. The method of claim 1, wherein:
acquiring the description information of the external equipment comprises:
acquiring an identification of a state of a keyboard of the external equipment, wherein the identification of the state of the keyboard of the external equipment is configured to be used for identifying a keyboard type with the identified state; and
determining the keyboard type of the external equipment based upon the acquired description information of the external equipment comprises:
searching for a keyboard type corresponding to the acquired identification of the state of the keyboard of the external equipment in a preset corresponding relationship between respective identified states of a keyboard and respective keyboard types;
when the searched for corresponding keyboard type is found to be a partial keyboard type, identifying the keyboard type of the external equipment as being a partial keyboard type; and
when the searched for corresponding keyboard type is found to be a full keyboard type, identifying the keyboard type of the external equipment as being a full keyboard type.

6. The method of claim 1, wherein generating the equipment acknowledgement of the external equipment and establishing the connection of the smart terminal to the external equipment, based upon the determined keyboard type, comprises:
generating a wireless equipment acknowledgment of the external equipment, based upon the determined keyboard type, and
establishing a wireless connection of the smart terminal with the external equipment, based upon the determined keyboard type.

7. The method of claim 1, further comprising:
in response to an input operation being requested, determining the keyboard type of the external equipment;
when the keyboard type of the external equipment is determined to be a partial keyboard type, displaying a soft keyboard input system of the smart terminal and performing the input operation with the soft keyboard input system; and
when the keyboard type of the external equipment is determined to be a full keyboard type, performing the input operation with a keyboard of the external equipment.

8. A method for connecting external equipment to a smart terminal, applied in the external equipment, the method comprising:
in response to detecting that the smart terminal is connected with the external equipment, reporting description information of the external equipment; and
establishing a connection of the external equipment to the smart terminal, based upon the reported description information of the external equipment.

9. The method of claim 8, further comprising:
before detecting the connection of the external equipment with the smart terminal, setting the description information of the external equipment based upon at least one predetermined characteristic of a keyboard of the external equipment.

10. The method of claim 9, wherein setting the description information of the external equipment based upon the at least one predetermined characteristic of the keyboard of the external equipment comprises:
setting the keyboard service finding protocol recording information based upon the at least one predetermined characteristic of the keyboard of the external equipment, wherein the keyboard service finding protocol recording information is configured to be used for stating a key that is supported by the external equipment;
when the keyboard type of the external equipment is a full keyboard type, setting the keyboard service finding protocol recording information of the external equipment to state that the external equipment supports a preset letter key; and
when the keyboard type of the external equipment is a partial keyboard type, setting the keyboard service finding protocol recording information of the external equipment to state that the external equipment does not support the preset letter key.

11. The method of claim 9, wherein setting the description information of the external equipment based upon the at least one predetermined characteristic of the keyboard of the external equipment comprises:
creating a corresponding relationship between manufacturer identification information of the external equipment and a keyboard type of the external equipment based upon the at least one predetermined characteristic of the keyboard of the external equipment;
when the keyboard type of the external equipment is a full keyboard type, creating the corresponding relationship between the manufacturer identification information of the external equipment and a full keyboard type; and
when the keyboard type of the external equipment is a partial keyboard type, creating the corresponding relationship between the manufacturer identification information of the external equipment and a partial keyboard type.

12. The method of claim 9, wherein setting the description information based upon the at least one predetermined characteristic of the keyboard of the external equipment comprises:
setting an identification of a state of the keyboard of the external equipment based upon the at least one predetermined characteristic of the keyboard of the external equipment; when the keyboard type of the external equipment is a full keyboard type, setting the identification of the state of the keyboard of the external equipment as a first state; and
when the keyboard type of the external equipment is a partial keyboard type, setting the identification of the state of the keyboard of the external equipment as a second state.

13. A device for connecting a smart terminal to external equipment, the device comprising:
a processor; and
a memory for storing instructions executable by the processor;
wherein the processor is configured to:
in response to detecting that the external equipment is connected with a smart terminal, acquire description information of the external equipment;
determine a keyboard type of the external equipment, based upon the acquired description information of the external equipment;
generate an equipment acknowledgement of the external equipment, based upon the determined keyboard type; and
establish a connection of the smart terminal to the external equipment, based upon the determined keyboard type.

14. The device of claim 13, wherein the acquired description information of the external equipment is set based upon at least one predetermined characteristic of a keyboard of the external equipment.

15. The device of claim 13, wherein the processor is further configured to:
acquire keyboard service finding protocol recording information of the external equipment, wherein the keyboard service finding protocol recording information is configured to be used for stating a key that supported by the external equipment;
determine whether the external equipment supports a preset letter key, based upon the acquired keyboard service finding protocol recording information;
when the external equipment is determined to support the preset letter key, identify the keyboard type of the external equipment as being a full keyboard type; and
when the external equipment is determined not to support the preset letter key, identify the keyboard type of the external equipment as being a partial keyboard type, and that the partial keyboard type allows a smart terminal to display a soft keyboard input system during an input operation.

16. The device of claim 13, wherein the processor is further configured to:
acquire manufacturer identification information of the external equipment; and
search for a keyboard equipment type corresponding to the acquired manufacturer identification information of the external equipment in a preset corresponding relationship between respective manufacturer identification information and respective keyboard types;
when the searched for corresponding keyboard type is found to be a partial keyboard type, identify the keyboard type of the external equipment as being a partial keyboard type; and
when the searched for corresponding keyboard equipment type is found to be a full keyboard type, identify the keyboard type of the external equipment as being a full keyboard type.

17. The device of claim 13, wherein the processor is further configured to:
acquire an identification of a state of a keyboard of the external equipment, wherein the identification of the state of the keyboard of the external equipment is configured to be used for identifying a keyboard type with the identified state;
search for a keyboard type corresponding to the acquired identification of the state of the keyboard of the external equipment in a preset corresponding relationship between respective identified states of a keyboard and respective keyboard types;
when the searched for corresponding keyboard type is found to be a partial keyboard type, identify the keyboard type of the external equipment as being a partial keyboard type; and
when the searched for keyboard type is found to be a full keyboard type, identify the keyboard type of the external equipment as being a full keyboard type.

18. The device of claim 13, wherein the processor is further configured to:
generate a wireless equipment acknowledgement of the external equipment, based upon the determined keyboard type, and
establish a wireless connection of the smart terminal with the external equipment, based upon the determined keyboard type.

19. The device of claim 13, wherein the processor is further configured to:
in response to an input operation being requested, determine the keyboard type of the external equipment;
when the keyboard type of the external equipment is determined to be a partial keyboard type, display a soft keyboard input system of the smart terminal and perform the input operation with the soft keyboard input system; and
when the keyboard type of the external equipment is determined to be a full keyboard type, perform the input operation with a keyboard of the external equipment.

20. A device for connecting external equipment to a smart terminal, the device comprising:
a processor; and
a memory for storing instructions executable by the processor;
wherein the processor is configured to:
in response to detecting that the smart terminal is connected with the external equipment, report description information of the external equipment; and
establish a connection of the external equipment to the smart terminal, based upon the reported description information of the external equipment.

21. The device of claim 20, wherein the processor is further configured to:
before detecting the connection of the external equipment with the smart terminal, set the description information based upon at least one predetermined characteristic of a keyboard of the external equipment.
